(19) United States
(12) Patent Application Publication
(10) Pub. No.: US 2003/0171982 A1
(43) Pub. Date: Sep. 11, 2003

(54) Process of finding the best rap musicians

(76) Inventor: Clinton R. Paul, St. Paul, MN (US)

Correspondence Address: Mark Goldberg, 1200 Alexandra Blvd., Crystal Lake, IL, 60014, US

(21) Appl. No.: 10/092,269

(22) Filed: Mar. 6, 2002

(51) Int. Cl. G06F 17/60

(52) U.S. Cl. 705/12

(57) ABSTRACT

The present invention comprises a process for selecting the best rap musicians comprising the steps of connecting at least two competitors on a network, such as a computer network, providing means for the competitors and observers to register on the network, providing means for the competitors to input their words, usually by microphone and in preferred cases by a video web camera. The competitors and observers will vote on their preferred competitor and following a series of competitions, a winner of each group or stage competition will be selected regarding said competitors and means to tabulate said vote. In the preferred embodiment of the invention, these competitions will be used to select the individuals to present live concerts, to make commercial records or to appear on televised music programs.

### FIELD OF THE INVENTION

This invention relates to a process and a system for determining the best rap musician or other type of musician.

### BACKGROUND OF THE INVENTION

A form of music/poetry that has become increasingly popular over the past twenty years is rap music. In this energetic form of expression, the key is the composition of lyrics that go with the beat and convey a message to the listener. Rap is a popular music style which was born in the 70's and early 80's in the Black/Hispanic community of South Bronx, New York. Rap is part of an urban American subculture called hip hop and originally derived from Afro-American popular music forms, most of all funk. The word rap refers to the singing style, which actually resembles speaking more than singing. Rapping is very fast, rhythmical and accentuated, in some ways having similarities to the jazz-singing style called scat. An important part of rap music has been scratching, which is a product of the vinyl recording, pre-CD era. It involves playing two records all at once on two turntables plugged into the same speaker, and changing the records quickly. The actual scratching means stopping the rotating record by hand and moving the record back and forth with the needle still on the surface of the record, which produces a scratching sound with different rhythmic patterns. Like other types of creative activities, the creation of imaginative rap is stimulated and encouraged through communication between people who are interested in this medium.

In locations around the United States and in many other countries, people get together to “battle rap”. Battle rapping is one of the oldest styles of rap. Two or more people meet and start competing. Battle rapping is based on spontaneity, verbal wit, imagination and quick reactions. Another, perhaps more sensible, comparison could be the West Indian calypso competitions. Battle rapping may sound offensive, but it is significant as being a non-violent way of competing and getting rid of extra energy and frustrations. In a battle rap, the individuals taking part will each have a period of time, for example 30 to 60 seconds, to “do battle”—to perform their rap. These can be organized competitions or informal gatherings. The disadvantage to these prior art competitions is that they are limited by geography or by the need to enter into a specific contest to compete. In the present invention, it has been first discovered that these battle raps can be conducted in an organized basis on a network of computers. As originally contemplated, the individuals who are interested in participating will register on an Internet web site designed for individual parties to perform their rap, with the ability of those registered on the web site to vote for the best rap performer. As computers become more portable, it is expected that individuals will be able to connect to the same type of Internet web site from a hand held computer or other device that provides the means to communicate to the web. The organizer of the web site will be able to provide rewards for the best performers including monetary rewards as well as other rewards such as providing the winners with an opportunity to record with a commercial recording company. These recordings may be on a compact disk (CD), DVD, tape, computer storage media, online or other recording media. In addition, live concert performances may be organized for the highest scoring performers.

The Internet has provided the means for collaboration by people who are remote. There are a variety of computer programs that link people together by chat, written, vocal and video. In addition, there are a variety of messenger programs that are well known to allow the transmission of messages and files between people at different computers. One such patent is U.S. Pat. No. 6,256,663, incorporated herein in its entirety, and covering a System and Method for Conducting Focus Groups Using Remotely Loaded Participants Over a Computer Network. Another interesting recent patent application covers a network system for composing music by collaboration of individuals at computer terminals. In this U.S. patent application 20010007960, published Jul. 12, 2001, incorporated herein in its entirety, the inventors provide for the collaboration by music composers on a network. However, previous to the present invention, there is not known to be any provision for remote competitors to compete in a battle rap or any similar competition. Rap has developed as a means for communicating on street corners and such, and for the first time the present invention provides an organized process for connecting rappers by computer.

### SUMMARY OF THE INVENTION

The present invention is a process for selecting the best rap musicians comprising the steps of connecting at least two competitors through a network, such as a computer network, providing means for the competitors to register on the network, providing means for the competitors to input their composition, such as by keyboard, mouse, microphone, camera, digitizing pad and the like, said input including written or typed words, audio and video, means for individuals connected to said network to input a vote regarding said competitors and means to tabulate said vote. This invention also comprises a system for musicians to share their rap music compositions, said system comprising a computer network in which each musician as well as observers are logged into a central web site. This central web site maintains a directory of members, a means for members to register and sign-in to the central web site, at least one area for members to input their rap music compositions and an area for members to input their vote regarding said compositions. In preferred embodiments of the present invention, there are several means for communicating between members, including written, voice and video chat.

### DETAILED DESCRIPTION OF THE INVENTION

The present invention features a system for conducting rap music competitions among participants with the various participants including at least one administrator, and at least one participant. It is anticipated that there can be hundreds and even thousands of participants at any one time with the number of participants only limited by the capacity of the network. A participant typically has access to a computer including a computer interface to be connected to a network, a computer input device such as a keyboard, a mouse, a microphone, a video camera or a digitizing notepad. Each computer connected to the network also typically includes a display device such as a computer monitor capable of displaying one or more “windows” or display areas of information. The invention as contemplated by the inventor involves the display of a page on a web site on the World Wide Web where participants may register to participate or sign in if they are already registered. There may be a means provided for the payment of membership fees by such participants, such as by secure transmission of credit card information or by other means of payment. It is also contemplated that there will be both practice areas on the web site that may be less competitive, especially for underage participants, as well as competition areas. Any of these areas may be divided into sections by age, sex, performance style or genre or by other criteria as may be contemplated by one skilled in the art. In addition, there may be multiple sections within any one criteria depending upon the number of competitors. The number of individuals within a particular section (also called a “quad” herein) may be limited by the administrator due to software limitations or other considerations such as the desire to complete a competition with the naming of a winner within a set period of time, generally from 1 to 2 hours in length.

In the membership sign-in area, there will be a means, such as a database, to determine that the user's identification and password are valid and that payment, if required, is up to date. The rules of the competition and the web site will be readily accessible in the sign up area and access to such rules shall be readily made available.

This invention provides for the participants to use written, spoken and/or visual means to input their creative compositions. In the case of the written word, the web site will provide an area for the participant to type their verse or otherwise input it into their computer and transmit the verse to a central server. Depending upon the rules of the competition and storage space constraints, there may be some word limit placed upon the length of the verse. A means may be provided on the web site for an authorized person to remove “banned words” and the verse will be made available to other registrants on the web site, either immediately or following review for compliance with the rules. The text or verse will be inspected by human or computer comparison against a list of forbidden words as well as other criteria such as general subject matter that may be imposed by the administrators of the site. These registrants, including will be allowed to judge or input a score for this verse and for the participant according to the rules designed by the administrator of the web site. In preferred embodiments of the invention, there will be means to insure that each individual can only vote in accordance with the rules of the site. For example, in order to insure a fair competition, it is contemplated that an individual may only vote once on any particular competition.

In the case of a practice area on the web site as well as in the competition areas, it is expected that the verses input by participants will be deleted on a regular basis by the administrator or stored in an archival section of the site that may or may not be made accessible by other registrants. The names/member ID or other identifying information of each winner or winners may be retained by the administrator, as deemed desirable. There may be some limits placed upon the number of times that an individual may compete or win a competition. In addition to submission of verses or other communication by the written word, a means may be provided for submission of the spoken word.

Some limitations will normally be placed upon the size of the file submitted or the amount of time of the submission. In some embodiments of the invention the participant will use a microphone and speak into the microphone, in real time and have their submission recorded using conventional means for replay upon the web site. These submissions may be accompanied by a musical background or not, as desired by the participant or as provided by the web site administrator. The web site itself may provide the musical background for use by participants and combine the submission with the music. As initially contemplated, it is anticipated that the participant will record their submission using their own computer or other recording means and then transmit the file in the appropriate format to the web site. In the preferred embodiment of the invention the individual will have a video camera connected to their computer and will transmit both the audio and video of their submission in a “live” transmission. In another embodiment of the present invention, the participant will transmit their submission as a file or files to the central web site for subsequent retransmission to other participants who desire such receipt. Such files may be transmitted by e-mail, direct uploaded to the server or mailed on a computer storage medium such as a floppy disk to the appropriate address.

In a more advanced embodiment of the invention, there will be the ability for two or more participants to intertwine their submissions, i.e., participant #1 submits some lines of rap, followed by participant #2 and then participant #1 and so on. In this more advanced embodiment, the product may more closely resemble the original street corner battle raps.

Individuals accessing the web site will be able to access the user names of the competitors or otherwise identify them and see the votes or scores that have been received. The voting or scoring information will be updated on a regular basis. There will be a means for the registrants to vote for the favorite competitors as well as a means to record such vote and communicate the votes to the registrants. There may be provided a news section with information that may be of interest to participants in the web site as well as links to other informative sites.

In addition to the areas of the web site that are available to the members, there will be an administrative area, accessible only to administrators having the necessary password. Among the functions performed by the administrators, in addition to the standard functions that are normally performed by web site administrators, will be the ability to ban members for inappropriate actions, to edit the banned words list, to list local musicians and bands, review the list of members, to process payment transactions and to create and modify lists of winners.

Upon successful sign-in to the site, members will be able to access the above described practice areas. In addition, there will be the ability to access the competition areas of the web site. There are expected to be separate log-in areas for those who are under the age of 18 from the adult areas of the web site. In addition, there may be separate rooms or competition areas such as for different languages, subject matter, age, sex or other distinguishing feature of the member. Due to the international nature of the medium of rap, there are likely to be participants from many of the countries that are connected to the World Wide Web.

There may be other features provided, such as the sale of merchandise bearing the logo of the web site or otherwise related to the subject matter of the submissions to the web site. There will normally be a chat area, where members may converse one on one or in groups with each other. Such chat may be by words inputted into a member's computer by keyboard, by voice as inputted into a microphone connected to their computer or by other means known to those skilled in the art. The invention as contemplated herein, is designed for use on computers that are part of a network, such as the Internet. However, it is expected that this invention may be used by other means of communication that are connected to a network, as long as there is some means for input of the written or typed word, the spoken word or by video means. Such means would include hand held communication devices, such as a hand held computer, cell phones and other devices that are connected to a network by wire or wireless means. It may be that there will be some combination of different communication devices employed at any particular time. There need to be at least two individuals, preferably at least eight individuals and most preferably about sixteen individuals participating at any particular time for the invention to be practical. There will be some maximum number of individuals who may participate in a particular competition, but multiple competitions are likely to be conducted simultaneously, depending upon the computer resources that are employed. The great advantage of the present invention is to allow participants to be remote geographically, yet compete in a battle rap together. A further significant advantage is the ability of commercial music producers to discover talented individuals to sign to contracts for production of CDs or other commercial music products or for live concerts. This invention provides an opportunity for such music producers to discover new talent in locations around the world.

In the preferred embodiment of the invention, a potential performer or participant will first go to the Internet web site that is hosting the battle rap competition. That person will enter their user name and password, or register, if this is the first time for them to go to the web site. That person then will select the particular battle stage that has openings for competitors or observers. Through practice it is preferred to limit a particular stage to sixteen (16) competitors due to the desire to provide reasonable opportunity to compete, yet complete a stage within a discrete period of time. A competition could include more competitors if the period for competition is lengthened. The person will decide whether to compete or observe upon entrance. If the person decides to be an observer, then they will select the genre and individual stage of competition to observe. The observer will be able to chat with others who are observing and competing in that particular stage. In addition the observer will listen to the rap and then cast a vote as to the preferred competitor. It is anticipated that a battle rap stage will be a series of one on one competitions. After observing for a desired period of time, the observer will either log off the web site or decide to enter a battle rap stage as a competitor.

If an individual decides to compete and becomes a contestant, then the first decision will be to choose the genre of rap and enter a battle rap stage that is not full. A battle rap stage will be open to competitors until full or the stage may close to additional competitors once a minimum number of such competitors has entered the stage. At this point, the competitor or contestant has the same options as the observer (to chat, listen and vote) as well as to wait until it is their turn to compete. Once it is their turn to compete, a signal will be provided, giving a several second countdown, such as a three second warning, followed by a signal to speak (or “spit”) their rap into their microphone for transmittal to the web site and to all the observers and contestants listening to that particular battle rap stage. As presently contemplated, each competitor will have a thirty second time limit to present their rap. A timer presenting the time remaining may appear on the screen of the competitor as well as a signal when the time is up. A background beat may be provided by the web site for each competitor. In most instances, this rap will be recorded so that it may be listened to by other members of the rap web site at a time following the competition. Following every two contestants, those observing the rap will vote upon the preferred competitor. The winner of each two person competition will have opportunity to compete against another competitor, while the loser may choose to either stop competing or to start over by entering a new stage. In other versions of a battle rap competition, it may be that a person is not eliminated from a battle rap stage until they have lost two or even more one on one competitions. Eventually, one competitor will be the winner of a stage. In instances of sixteen competitor stages, it is anticipated that each stage will be about 90 minutes in duration. In the preferred embodiment of the invention, four stages (having a total of 64 competitors) will be grouped together and a combined winner of the four stages will be selected as the quad winner. The quad winner will be the champion for that day and will be entered into consideration for the various possible rewards contemplated in connection with the competition. Such winners may be selected to participate in live concerts or to make commercial recordings of their rap compositions.

In addition to the main purpose of the present invention being the selection of the best competitor, it is intended that the individual or company that administers the web site will be able to make commercial use of information generated in the process of the registrations and competitions on the web site. For example, registrants will be required to input their address during the process of registering on the web site. The web site administrator will be able to use such information to determine the geographical areas with the highest interest in rap music in general and also in particular genres of such music. This demographic information will be useful in determining the locations in which to schedule concerts and sales of recorded music.

While this invention has been designed and developed for rap music, it may readily be usable for other forms of music or poetry that may develop. It would work very well for individuals in any genre of poetry or prose, not only for rap music. One particular genre of music that has similar types of competitions as battle rap, is reggae music. It would be expected that the present invention would be useful for practice or competitive competitions involving music genres as found in other countries as well as the rap music that began in the United States.

I claim:

1. A process for selecting the best rap performer from a group of competitors, comprising the steps of:
a) providing an internet web site that is accessible to competitors interested in competing in a rap music competition and to observers interested in observing said competition;
b) providing a registration function on said internet web site in which said competitors and observers input prescribed information and pay prescribed fees;
c) providing a performance function on said web site for said competitors to input a rap entry comprising words, music or a combination thereof to said web site and to display said entry to each competitor and observer through a computer network and;
d) providing a voting function for said competitors and observers to indicate a preferred competitor and to communicate said preference to said competitors and observers.

2. The process of claim 1 wherein said competitors use a microphone to input said rap entry.

3. The process of claim 2 wherein said competitors input a visual image showing their rap entry by transmitting a web cam video to said performance function.

4. The process of claim 1 wherein said prescribed information input during registration on said web site is stored in a data base.

5. The process of claim 4 wherein said information is analyzed to determine one or more geographic locations exhibiting a concentration of observers and competitors.

6. The process of claim 1 wherein said process further comprises a chat function wherein said competitors and observers are able to communicate with one or more other competitors and observers while logged onto said web site.

7. The process of claim 6 wherein said comments are communication is by a text message board or an internet instant messaging system.

8. The process of claim 1 wherein a winning competitor is selected to receive at least one reward selected from the group consisting an opportunity to participate in a live performance at a concert or a performance on television, money, merchandise, discounts and an opportunity to make a commercial recording.

9. A system for selecting rap musicians, said system comprising:
a. at least two information processing terminals and at least one control station for connecting said information;
b. a means for participants to input an entry into said terminal and communicate said entry to other persons connected to said control station;
c. a means to store said entries in a computer and to provide access to other persons to view said entries;
d. a means for said other persons to input a rating of said entries; and:
e. a means to communicate such ratings to the participants and the other persons.

10. The system of claim 9 further comprising a means for participants and other persons to register and enter information for collection on a central data base.

11. The system of claim 10 wherein said information includes information by which an administrator of said data base may collect a monetary fee from said participants and other persons.

12. The system of claim 9 wherein participants with the highest ratings receive as a prize an opportunity to communicate their entry to individuals outside of said system.

13. The system of claim 9 wherein said input means is selected from the group consisting of a keyboard, a mouse, a microphone, a camera and a digitizing tablet.

14. The system of claim 9 further comprising a conversation section that allows communication between a participant and one or more other persons connected to said system.
